(19) United States
(12) Patent Application Publication
(10) Pub. No.: US 2026/0119232 A1
(43) Pub. Date: Apr. 30, 2026

(54) REVERSE-OFFLOAD OF TASKS BETWEEN DATA PROCESSORS

(71) Applicant: NVIDIA Corp., Santa Clara, CA (US)

(72) Inventors: Alon Amid, Haifa (IL); Matthias Johannes Langer, Shanghai (CN); Tomer Bar-On, Haifa (IL); Omer Heymann, Moshav Tzofit (IL)

(73) Assignee: NVIDIA Corp., Santa Clara, CA (US)

(21) Appl. No.: 18/930,365

(22) Filed: Oct. 29, 2024

(51) Int. Cl. G06F 9/48; G06F 9/54

(52) U.S. Cl. CPC G06F 9/4856; G06F 9/4881; G06F 9/544

(57) ABSTRACT

Reverse offload mechanisms that utilize a second processor to receiving a workload from a first processor, the workload including multiple tasks, where the second processor collects portions of the tasks from a set of co-executing threads in the second processor and dispatches portions of the tasks to queues for threads of the first processor, and in response to one or more of status indications satisfying a completion condition for the first portions of the tasks, combines first partial results of the tasks from the set of co-executing threads with second partial results of the portions of the tasks from the first processor.

### BACKGROUND

Modern computer systems often utilize multiple data processors. For example, a modern computer system may utilize one or more central processing unit (CPU) and one or more graphics processing unit (GPU). On such systems the execution of a computing workload may be distributed among the data processors. For example, a deep learning computing workload such as training or inference of an artificial intelligence model may be executed on one or more CPUs with portions (kernels) of the workload accelerated on one or more GPUs.

A portion of a kernel or other task offloaded to a helper processor may in some cases be more efficiently executed by the source processor that offloaded the task. In these cases, the portion may be “reverse offloaded” from the helper processor back to the source processor. An example of when this may occur is when the CPU has offloaded a deep learning kernel to the GPU for accelerated processing. The CPU may comprise a higher memory capacity than a GPU, and the interconnect between the CPU and the GPU may have limited bandwidth. It may be computationally more efficient to reverse offload memory-bandwidth intensive reduction operations of the deep learning kernel back from the GPU to the CPU to reduce the traffic bandwidth over the CPU-GPU interconnect.

Conventional workload sharing mechanisms may involve re-structuring the workload instruction sequence and partitioning the workload into separate kernels in specific ways so that the portions of the work that would otherwise be reverse-offloaded are instead executed as part of the main (source) processor control thread. This approach may prove burdensome and inflexible for some workloads.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a reverse offload mechanism in accordance with one embodiment.

FIG. 2 depicts a reverse offload mechanism is accordance with another embodiment.

FIG. 3 depicts a reverse offload process in accordance with one embodiment.

FIG. 4 depicts an integrated circuit in accordance with one embodiment.

FIG. 5 depicts a computing system in accordance with one embodiment.

FIG. 6 depicts a parallel processing unit in accordance with one embodiment.

FIG. 7 depicts a processing system in accordance with one embodiment.

FIG. 8 depicts an exemplary processing system in accordance with another embodiment.

FIG. 9 illustrates an exemplary data center 900, in accordance with at least one embodiment.

### DETAILED DESCRIPTION

Mechanisms are disclosed for more efficient and flexible reverse-offloading of computing tasks between data processors. The mechanisms may utilize in-memory queues in a coherent memory system shared among multiple data processors. Examples are provided for reverse-offloading between GPUs and CPUs, and in particular reverse-offloading vector reduction operations such as computation of partial products, filtering, and averages. However, the disclosed mechanisms are generally applicable to reverse offloading of any computational task between data processors.

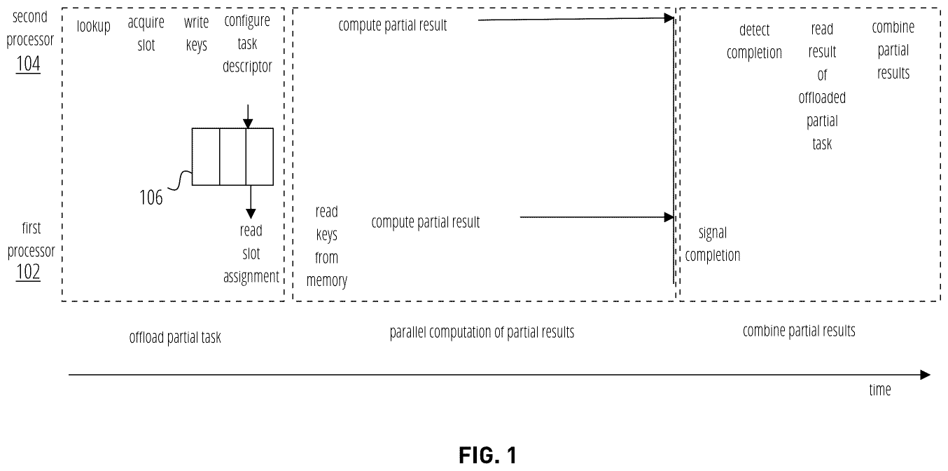

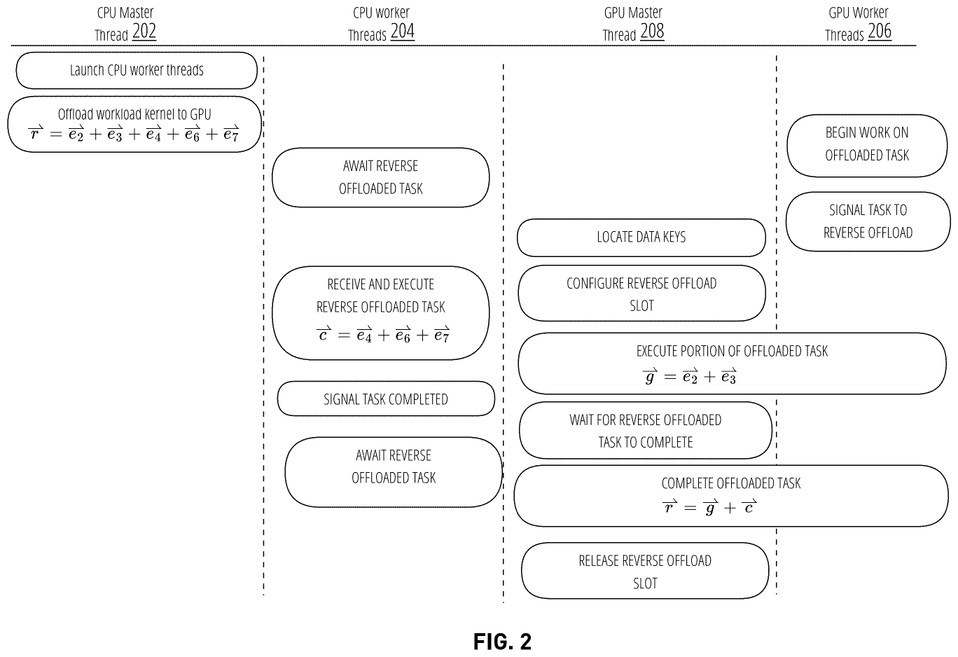

FIG. 1 depicts an embodiment of a reverse offload mechanism between a first processor 102 and a second processor 104. FIG. 2 depicts an implementation of a reverse offload mechanism between a central processing unit (CPU) and a graphics processing unit (GPU). The depicted examples are readily extensible to reverse offloading between one or more first processors and one or more second processors, for example for sum-of-products reduction or more generally for distributed computation of artificial intelligence-related tasks. The machine-readable instructions of application logic may configure the various processors, e.g., may configure one or more CPU and one or more GPU, to implement the reverse offload mechanisms. A computer system may store the application logic on, or access it from, one or more non-transitory machine-readable media such as a hard drive (including solid-state drives) or a read-only memory.

A reverse offloaded task may be configured as a data structure in a physical memory address region that is shared between the first processor 102 and the second processor 104. This data structure is referred to herein as a ‘task descriptor’. Task descriptors be reserved and assigned from a pre-allocated pool of task descriptors. The shared memory region may comprise an instruction and/or data address space utilized by the first processor 102, for example a Dynamic Read Only Memory storing data values used in instructions executed by the first processor 102.

In one embodiment one or more shared memory queue 106 may be utilized to implement execution ordering of reverse offloaded computations, e.g., using First In First Out (FIFO) structured queue(s). In one embodiment a distinct FIFO queue is utilized for each worker thread or set of worker threads of the first processor 102 that processes reverse offloaded tasks from the second processor 104.

An offloaded workload, e.g., a deep learning kernel task, may be offloaded for example by a master thread of the first processor 102 to the second processor 104. The second processor 104 receives and begins processing the offloaded task. Various worker threads of the second processor 104 then encounter computations within the offloaded task that are more efficiently processed by reverse offloading back to the first processor 102. The worker threads may notify a master thread of the second processor 104 about the computations to reverse offload.

The master thread of the second processor 104 may gather up these notifications from the worker threads of the second processor 104 and in response may identify (i.e., looks up) and acquire available slots in shared memory queues 106 associated with worker threads of the first processor 102 that are available to receive reverse offloaded tasks from the second processor 104.

The second processor 104 writes keys (e.g., references or identifiers of data vectors) for the various tasks into the slots of the shared memory queues 106 and configures task descriptors into the slots. The associated worker thread(s) of the first processor 102 access these settings via the slot either directly or indirectly. Generally, the keys are any pointer, index, or other identifier of data needed for the reverse offloaded task, and the task descriptor comprises a code indicating what type of processing to perform on the data and where to write back the result(s).

The second processor 104 proceeds to compute the portion of the offloaded task that was not reverse offloaded back to the first processor 102. In parallel, worker threads of the first processor 102 process the one or more reverse offloaded tasks. Each of the first processor 102 and the second processor 104 generates partial results of the offloaded task.

The first processor 102 signals the second processor 104 that the partial results of the reverse offloaded task(s) are available. This signal may take the form of a setting in the corresponding task descriptor. The second processor 104 detects the completion indication and reads the partial result(s) of the reverse offloaded task, and combines this partial result(s) with the partial result(s) that were not reverse offloaded, completing the task that was originally offloaded to the second processor 104 from the first processor 102.

FIG. 2 depicts a reverse offload mechanism in one embodiment wherein a CPU offloads tasks to a GPU, and the GPU subsequently reverse offloads a subset of these tasks back to the CPU. A CPU master thread 202 launches one or more CPU worker threads 204 that are available to handle reverse offloaded tasks from the GPU. The CPU master thread 202 also offloads a kernel task to the GPU.

The CPU worker threads 204 await reverse offloaded tasks from the GPU, using any established thread waiting mechanisms (e.g., polling a memory location shared with the GPU). The GPU worker threads 206 begin executing the offloaded kernel task, and at some point encounter indications (e.g., instructions) that some of the offloaded task should be reverse offloaded back to the CPU. The GPU worker threads 206 provide indications back to the GPU master thread 208 of the tasks to be reverse offloaded. The GPU worker thread 206 gathers up these indications and locates the keys that identify the data in the CPU's address space needed for the reverse offloaded tasks, which may be fully or partially consolidated into one or more task descriptors by the GPU master thread 208.

Some or all of the tasks to reverse offload may utilize data values, e.g., data vectors, that are located in the address space of the CPU worker threads 204, as indicated in the exemplary CPU table below. The GPU master thread 208 may consolidate the keys for locating these data values into one or more task descriptors.

CPU Table

| Key | Data Vector |
|---|---|
| 4 | [symbol] |
| 5 | [symbol] |
| 6 | [symbol] |
| 7 | [symbol] |
| 8 | [symbol] |
| 9 | [symbol] |

The task descriptor(s) for the task(s) to reverse offload may be configured into the slot(s) of the (one or more) shared memory queues 106 of the CPU worker threads 204. The status of these task descriptor(s) may be set to ‘ready’.

The GPU worker threads 206 proceed to execute the portions of the offloaded task that were not reverse offloaded back to the CPU worker threads 204, e.g., as indicated in the GPU table below. Once the GPU worker threads 206 complete said execution, they wait for an indication that the reverse offloaded tasks have completed (e.g., by waiting at a synchronization barrier).

GPU Table

| Key | Data Vector |
|---|---|
| 2 | [symbol] |
| 3 | [symbol] |

The CPU worker threads 204 receive and execute the reverse offloaded tasks. The CPU worker threads 204 look up the data values to utilize in the reverse offloaded tasks from the keys or other indications provided in the task descriptor, read the data values from memory, and then perform the reverse offloaded task. In one embodiment, this task is a reduction of a vector to a single value (e.g., a sum of products reduction). The CPU worker threads 204 may write the results of the reverse offloaded task into memory addresses specified by the task descriptor.

Once said execution is completed, the CPU worker threads 204 provide an indication that the reverse offloaded tasks have completed, along with the results. This indication and the result may be provided directly by the CPU worker threads 204 to the GPU master thread 208 via the task descriptor(s) (e.g., by changing a status setting in the task descriptors). Alternatively, the indications and results may be provided to the CPU master thread 202 which in turn notifies the GPU master thread 208 via the corresponding task descriptor(s). Once a CPU worker thread 204 completes a reverse offloaded task, it may monitor its corresponding task queue for a task descriptor of a next reverse offloaded task that is ‘ready’.

Once the reverse offloaded tasks complete, the results are combined by the GPU worker threads 206 with the results of the offloaded task that was not reverse offloaded, thereby completing the offloaded task. The slot(s) in the shared memory queues 106 that was utilized by the reverse offloaded tasks may then be released by the GPU master thread 208.

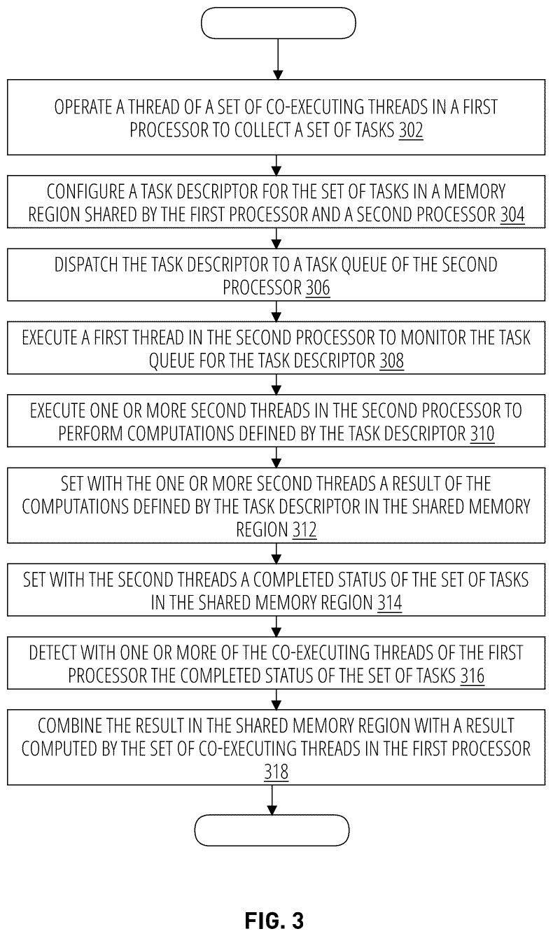

FIG. 3 depicts a distributed workload execution process in one embodiment.

At block 302, one thread (e.g., the GPU master thread 208) of a set of co-executing threads (e.g., the GPU worker threads 206) in a first processor (e.g., a GPU) collects a set of tasks (and potentially data keys for those tasks) from the set of co-executing threads.

At block 304, a task descriptor is configured for the set of tasks in a memory region (e.g., shared memory queues 106) shared by the first processor and a second processor (e.g., a CPU). This task descriptor may consolidate the tasks of the set of co-executing threads to reverse offload from the second processor.

The task descriptor is dispatched to a task queue (e.g., shared memory queue 106) of the second processor (block 306). A first thread (e.g., CPU master thread 202) in the second processor is executed to monitor the task queue for reverse offloaded task descriptors (block 308).

One or more second threads in the second processor (e.g., CPU worker threads 204) are executed to perform computations defined by the task descriptor (block 310). The second threads (and/or the first thread) set results of the computations defined by the task descriptor back into the shared memory region (block 312) and sets the status of the task descriptor to completed (block 314), making the results of the reverse offloaded tasks available to the first processor.

The co-executing threads of the first processor detect the completed status of the reverse offloaded task(s) (block 316) and combine the result of the reverse offloaded task(s) provided in the task descriptor or other area of the shared memory region with a result computed by the set of co-executing threads in the first processor (block 318).

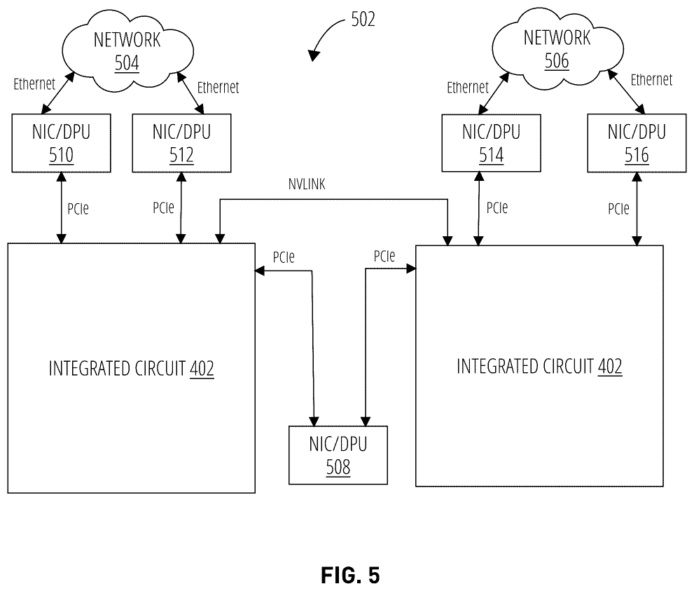

FIG. 5 is a block diagram of a computing system 502 having two processing devices coupled to each other and to multiple networks 504, 506 according to at least one embodiment. The computing system 502 is designed with multiple integrated circuits 402 (referred to as processing devices), where each integrated circuit includes a central processing unit 404 and two (or more) graphics processing units 406, 408, forming a powerful and flexible architecture. These processing devices may be interconnected via an NVLink (or other high-speed interconnect), enabling high-speed communication between the processing devices 402, and may also communicate through a Network Interface Card (NIC) or Data Processing Unit (DPU) 508 to enable efficient data transfer across the computing system 502. In some embodiments, aspects of the mechanisms disclosed herein may be implemented in a DPU or NIC.

A NIC and a DPU may serve different roles in network architecture, despite both facilitating network connectivity. A NIC may primarily provide a hardware interface to connect elements of a computing system to a network. A NIC may handle basic network communication tasks such as formatting, sending, and receiving data packets. The processing capabilities of a NIC may be limited to traditional network processing tasks.

A DPU comprises a specialized processing unit designed to offload and accelerate complex data processing tasks from the NIC or computing system. A NIC may combine a network interface, programmable processing, and storage capabilities and may perform tasks such as security, storage virtualization, and network telemetry.

The coupling of the processing devices 402 via NVLink enables data exchange and parallel processing, enhancing overall computational performance. A computing system 502 configured in this manner may process complex, multi-network tasks with high bandwidth and low latency. This configuration makes the computing system 502 suitable for demanding applications that consume significant processing power by current standards, such as artificial intelligence (AI), machine learning (ML), and data-intensive computing, while providing robust connectivity and scalability across various networked environments.

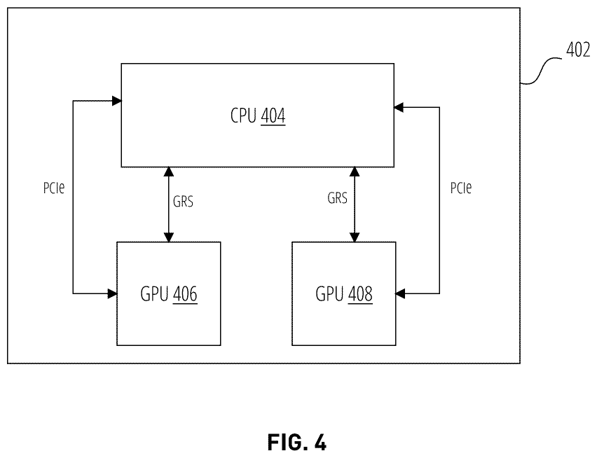

As depicted in the example embodiment of FIG. 4, the central processing unit 404 may be coupled to the graphics processing units 406, 408 via a die-to-die (D2D) or chip-to-chip (C2C) interconnect such as a Ground-Referenced Signaling interconnect (GRS interconnect). The central processing unit 404 may be coupled to the graphics processing units 406, 408 via PCIe (Peripheral Component Interconnect Express) interconnects.

The central processing unit 404 component of the integrated circuit 402 may be coupled to one or more network interface cards (NICs) or data processing units (DPUs), and these may be coupled to one or more networks. For example, as depicted in FIG. 5, the central processing unit 404 component of one of the integrated circuits 402 may be coupled to a network 504 via a pair of NICs or DPUs 510, 512. The NICs or DPUs 510, 512 may be coupled to the network 504 in a number of ways, for example over Ethernet (ETH), NVLINK, or InfiniBand (IB) connections. Likewise, the central processing unit 404 component of the other integrated circuit 402 may be coupled to a network 506 via a pair of NICs or DPUs 514, 516, and the NICs or DPUs 514, 516 may be coupled to the network 506 for example over Ethernet (ETH), NVLINK, or InfiniBand (IB) connections, for example.

The mechanisms disclosed herein may be implemented in and/or by computing devices utilizing one or more graphic processing unit (GPU) and/or general purpose data processor (e.g., a central processing unit or CPU). Exemplary architectures will now be described that may be configured to implement the mechanisms disclosed herein.

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

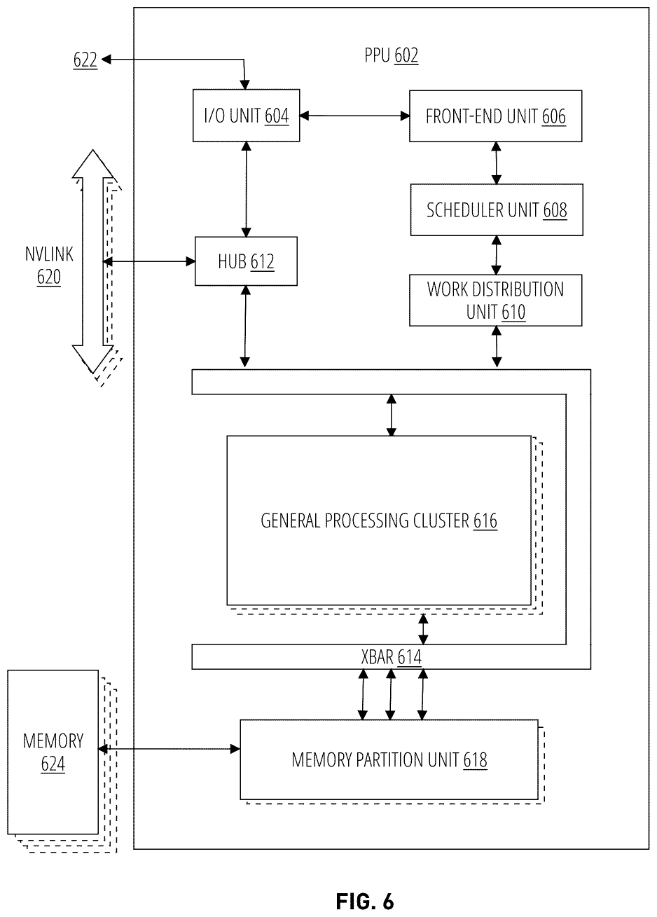

FIG. 6 depicts a parallel processing unit 602, in accordance with an embodiment. In an embodiment, the parallel processing unit 602 is a multi-threaded processor that is implemented on one or more integrated circuit devices. The parallel processing unit 602 is a latency hiding architecture designed to process many threads in parallel. A thread (e.g., a thread of execution) is an instantiation of a set of instructions configured to be executed by the parallel processing unit 602. In an embodiment, the parallel processing unit 602 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 602 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 602 modules may be configured to accelerate thousands of High Performance Computing (HPC), data center, and machine learning applications. The parallel processing unit 602 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 6, the parallel processing unit 602 includes an I/O unit 604, a front-end unit 606, a scheduler unit 608, a work distribution unit 610, a hub 612, a crossbar 614, one or more general processing cluster 616 modules, and one or more memory partition unit 618 modules. The parallel processing unit 602 may be connected to a host processor or other parallel processing unit 602 modules via one or more high-speed NVLink 620 interconnects. The parallel processing unit 602 may be connected to a host processor or other peripheral devices via an interconnect 622. The parallel processing unit 602 may also be connected to a local memory comprising a number of memory 624 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 624 may comprise logic to configure the parallel processing unit 602 to carry out aspects of the techniques disclosed herein.

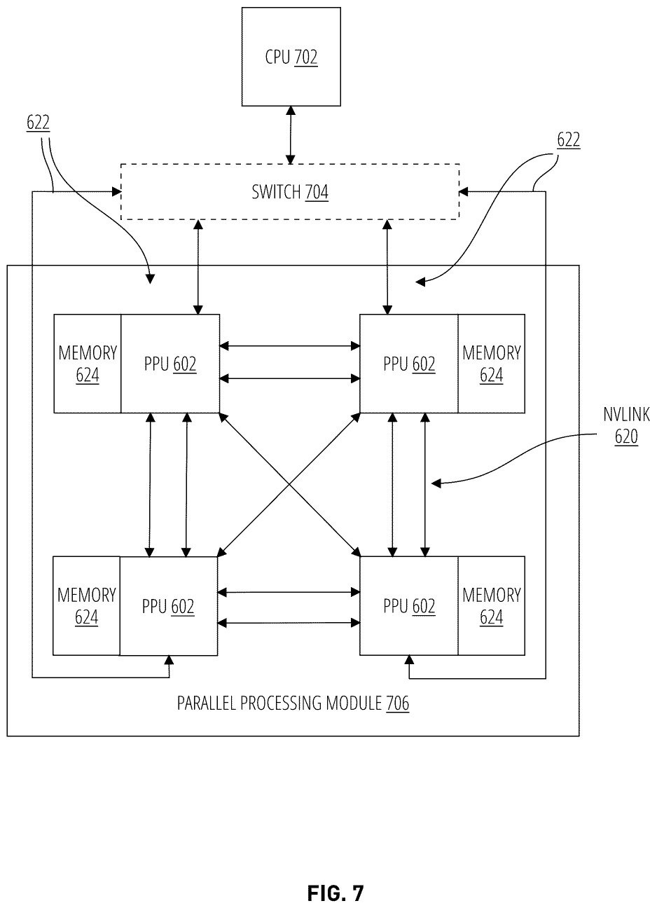

The NVLink 620 interconnect enables systems to scale and include one or more parallel processing unit 602 modules combined with one or more CPUs, supports cache coherence between the parallel processing unit 602 modules and CPUs, and CPU mastering. Data and/or commands may be transmitted by the NVLink 620 through the hub 612 to/from other units of the parallel processing unit 602 such as one or more copy engines, a video encoder, a video decoder, a power management unit, etc. (not explicitly shown). The NVLink 620 is described in more detail in conjunction with FIG. 7.

The I/O unit 604 is configured to transmit and receive communications (e.g., commands, data, etc.) from a host processor (not shown) over the interconnect 622. The I/O unit 604 may communicate with the host processor directly via the interconnect 622 or through one or more intermediate devices such as a memory bridge. In an embodiment, the I/O unit 604 may communicate with one or more other processors, such as one or more parallel processing unit 602 modules via the interconnect 622. In an embodiment, the I/O unit 604 implements a Peripheral Component Interconnect Express (PCIe) interface for communications over a PCIe bus and the interconnect 622 is a PCIe bus. In alternative embodiments, the I/O unit 604 may implement other types of well-known interfaces for communicating with external devices.

The I/O unit 604 decodes packets received via the interconnect 622. In an embodiment, the packets represent commands configured to cause the parallel processing unit 602 to perform various operations. The I/O unit 604 transmits the decoded commands to various other units of the parallel processing unit 602 as the commands may specify. For example, some commands may be transmitted to the front-end unit 606. Other commands may be transmitted to the hub 612 or other units of the parallel processing unit 602 such as one or more copy engines, a video encoder, a video decoder, a power management unit, etc. (not explicitly shown). In other words, the I/O unit 604 is configured to route communications between and among the various logical units of the parallel processing unit 602.

In an embodiment, a program executed by the host processor encodes a command stream in a buffer that provides workloads to the parallel processing unit 602 for processing. A workload may comprise several instructions and data to be processed by those instructions. The buffer is a region in a memory that is accessible (e.g., read/write) by both the host processor and the parallel processing unit 602. For example, the I/O unit 604 may be configured to access the buffer in a system memory connected to the interconnect 622 via memory requests transmitted over the interconnect 622. In an embodiment, the host processor writes the command stream to the buffer and then transmits a pointer to the start of the command stream to the parallel processing unit 602. The front-end unit 606 receives pointers to one or more command streams. The front-end unit 606 manages the one or more streams, reading commands from the streams and forwarding commands to the various units of the parallel processing unit 602.

The front-end unit 606 is coupled to a scheduler unit 608 that configures the various general processing cluster 616 modules to process tasks defined by the one or more streams. The scheduler unit 608 is configured to track state information related to the various tasks managed by the scheduler unit 608. The state may indicate which general processing cluster 616 a task is assigned to, whether the task is active or inactive, a priority level associated with the task, and so forth. The scheduler unit 608 manages the execution of a plurality of tasks on the one or more general processing cluster 616 modules.

The scheduler unit 608 is coupled to a work distribution unit 610 that is configured to dispatch tasks for execution on the general processing cluster 616 modules. The work distribution unit 610 may track a number of scheduled tasks received from the scheduler unit 608. In an embodiment, the work distribution unit 610 manages a pending task pool and an active task pool for each of the general processing cluster 616 modules. The pending task pool may comprise a number of slots (e.g., 32 slots) that contain tasks assigned to be processed by a particular general processing cluster 616. The active task pool may comprise a number of slots (e.g., 4 slots) for tasks that are actively being processed by the general processing cluster 616 modules. As a general processing cluster 616 finishes the execution of a task, that task is evicted from the active task pool for the general processing cluster 616 and one of the other tasks from the pending task pool is selected and scheduled for execution on the general processing cluster 616. If an active task has been idle on the general processing cluster 616, such as while waiting for a data dependency to be resolved, then the active task may be evicted from the general processing cluster 616 and returned to the pending task pool while another task in the pending task pool is selected and scheduled for execution on the general processing cluster 616.

The work distribution unit 610 communicates with the one or more general processing cluster 616 modules via crossbar 614. The crossbar 614 is an interconnect network that couples many of the units of the parallel processing unit 602 to other units of the parallel processing unit 602. For example, the crossbar 614 may be configured to couple the work distribution unit 610 to a particular general processing cluster 616. Although not shown explicitly, one or more other units of the parallel processing unit 602 may also be connected to the crossbar 614 via the hub 612.

The tasks are managed by the scheduler unit 608 and dispatched to a general processing cluster 616 by the work distribution unit 610. The general processing cluster 616 is configured to process the task and generate results. The results may be consumed by other tasks within the general processing cluster 616, routed to a different general processing cluster 616 via the crossbar 614, or stored in the memory 624. The results can be written to the memory 624 via the memory partition unit 618 modules, which implement a memory interface for reading and writing data to/from the memory 624. The results can be transmitted to another parallel processing unit 602 or CPU via the NVLink 620. In an embodiment, the parallel processing unit 602 includes a number U of memory partition unit 618 modules that is equal to the number of separate and distinct memory 624 devices coupled to the parallel processing unit 602.

In an embodiment, a host processor executes a driver kernel that implements an application programming interface (API) that enables one or more applications executing on the host processor to schedule operations for execution on the parallel processing unit 602. In an embodiment, multiple compute applications are simultaneously executed by the parallel processing unit 602 and the parallel processing unit 602 provides isolation, quality of service (QoS), and independent address spaces for the multiple compute applications. An application may generate instructions (e.g., API calls) that cause the driver kernel to generate one or more tasks for execution by the parallel processing unit 602. The driver kernel outputs tasks to one or more streams being processed by the parallel processing unit 602. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 7 is a conceptual diagram of a processing system implemented using the parallel processing unit 602 of FIG. 6, in accordance with an embodiment. The processing system includes a central processing unit 702, a switch 704, and multiple parallel processing unit 602 modules each and respective memory 624 modules. The switch 704 is depicted with dashed lines, indicating that it is optional in some embodiments. In some embodiments, aspects of the processing system may be implemented as an integrated circuit 402 utilizing the mechanisms disclosed herein.

The NVLink 620 provides high-speed communication links between each of the parallel processing unit 602 modules. Although a particular number of NVLink 620 and interconnect 622 connections are illustrated in FIG. 7, the number of connections to each parallel processing unit 602 and the central processing unit 702 may vary. The switch 704 interfaces between the interconnect 622 and the central processing unit 702. The parallel processing unit 602 modules, memory 624 modules, and NVLink 620 connections may be situated on a single semiconductor platform to form a parallel processing module 706. In an embodiment, the switch 704 supports two or more protocols to interface between various different connections and/or links.

In another embodiment (not shown), the NVLink 620 provides one or more high-speed communication links between each of the parallel processing unit modules (parallel processing unit 602, parallel processing unit 602, parallel processing unit 602, and parallel processing unit 602) and the central processing unit 702 and the switch 704 (when present) interfaces between the interconnect 622 and each of the parallel processing unit modules. The parallel processing unit modules, memory 624 modules, and interconnect 622 may be situated on a single semiconductor platform to form a parallel processing module 706. In yet another embodiment (not shown), the interconnect 622 provides one or more communication links between each of the parallel processing unit modules and the central processing unit 702 and the switch 704 interfaces between each of the parallel processing unit modules using the NVLink 620 to provide one or more high-speed communication links between the parallel processing unit modules. In another embodiment (not shown), the NVLink 620 provides one or more high-speed communication links between the parallel processing unit modules and the central processing unit 702 through the switch 704. In yet another embodiment (not shown), the interconnect 622 provides one or more communication links between each of the parallel processing unit modules directly. One or more of the NVLink 620 high-speed communication links may be implemented as a physical NVLink interconnect or either an on-chip or on-die interconnect using the same protocol as the NVLink 620.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. The various circuits or devices may also be situated separately or in various combinations of semiconductor platforms per the desires of the user. Alternately, the parallel processing module 706 may be implemented as a circuit board substrate and each of the parallel processing unit modules and/or memory 624 modules may be packaged devices. In an embodiment, the central processing unit 702, switch 704, and the parallel processing module 706 are situated on a single semiconductor platform.

In an embodiment, each parallel processing unit module includes six NVLink 620 interfaces (as shown in FIG. 7, five NVLink 620 interfaces are included for each parallel processing unit module). The NVLink 620 may be operated exclusively for PPU-to-PPU communication as shown in FIG. 7, or some combination of PPU-to-PPU and PPU-to-CPU, when the central processing unit 702 also includes one or more NVLink 620 interfaces.

In an embodiment, the NVLink 620 allows direct load/store/atomic access from the central processing unit 702 to each parallel processing unit module's memory 624. In an embodiment, the NVLink 620 supports coherency operations, allowing data read from the memory 624 modules to be stored in the cache hierarchy of the central processing unit 702, reducing cache access latency for the central processing unit 702. In an embodiment, the NVLink 620 includes support for Address Translation Services (ATS), enabling the parallel processing unit module to directly access page tables within the central processing unit 702. One or more of the NVLink 620 may also be configured to operate in a low-power mode.

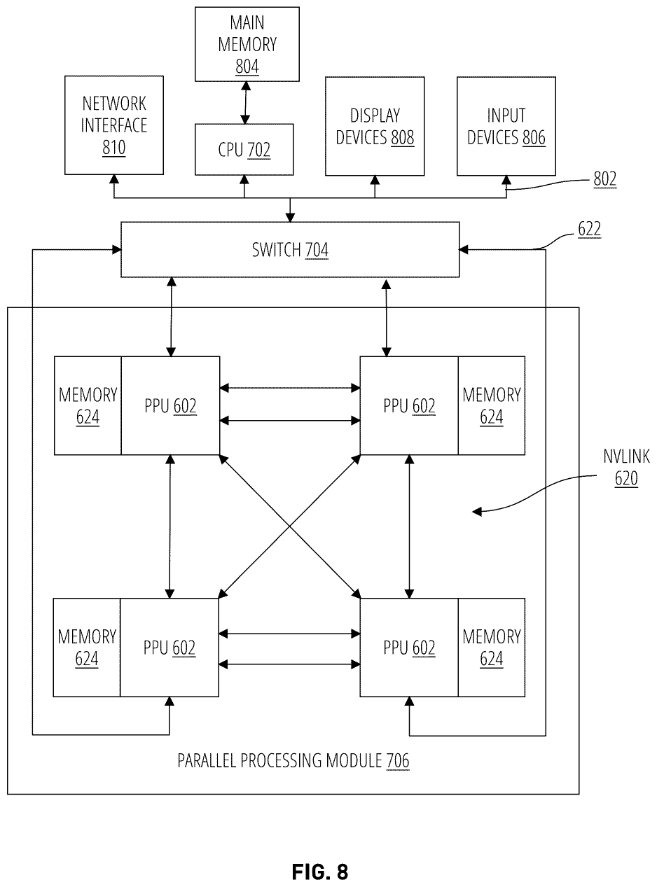

FIG. 8 depicts an exemplary processing system in which the various architecture and/or functionality of the various previous embodiments may be implemented. As shown, an exemplary processing system is provided including at least one central processing unit 702 that is connected to a communications bus 802. The communication communications bus 802 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 804. Control logic (software) and data are stored in the main memory 804 which may take the form of random access memory (RAM).

The exemplary processing system also includes input devices 806, the parallel processing module 706, and display devices 808, e.g. a conventional CRT (cathode ray tube), LCD (liquid crystal display), LED (light emitting diode), plasma display or the like. User input may be received from the input devices 806, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 810 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 804 and/or the secondary storage. Such computer programs, when executed, enable the exemplary processing system to perform various functions. The main memory 804, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

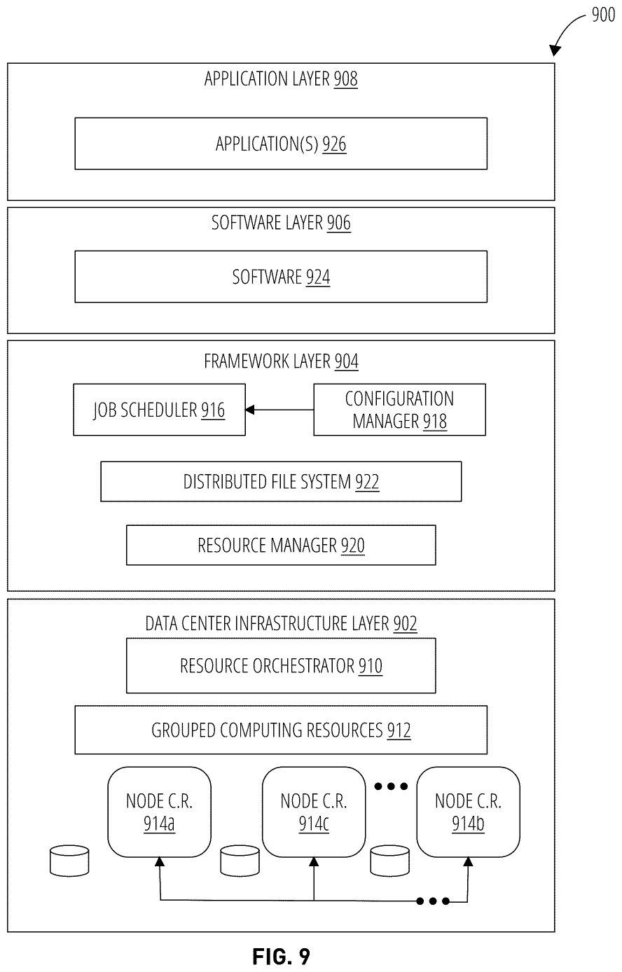

FIG. 9 depicts an exemplary data center 900, in accordance with at least one embodiment. In at least one embodiment, data center 900 includes, without limitation, a data center infrastructure layer 902, a framework layer 904, a software layer 906, and an application layer 908.

The data center 900 may comprise cooperative configurations (‘modules’) of central processing units 404 and graphics processing units 406, and memory 624 comprising instructions that configure these modules to carry out the mechanisms disclosed herein.

In at least one embodiment, as depicted in FIG. 9, data center infrastructure layer 902 may include a resource orchestrator 910, grouped computing resources 912, and node computing resources (node C.R.s) 914a-914b, 914c where “N” represents any whole, positive integer. In at least one embodiment, node computing resources may include, but are not limited to, any number of central processing units (CPUs) or other processors (including accelerators, field programmable gate arrays (FPGAs), graphics processors, etc.), memory devices (e.g., dynamic read-only memory), storage devices (e.g., solid state or disk drives), network input/output (NW I/O) devices, network switches, virtual machines (VMs), power modules, and cooling modules, etc. In at least one embodiment, one or more node computing resources from among node computing resources 914a-914b may be a server having one or more of the above-mentioned computing resources.

In at least one embodiment, grouped computing resources 912 may include separate groupings of node computing resources housed within one or more racks (not shown), or many racks housed in data centers at various geographical locations (also not shown). Separate groupings of node computing resources within grouped computing resources 912 may include grouped compute network, memory, or storage resources that may be configured or allocated to support one or more workloads. In at least one embodiment, several node computing resources including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 910 may configure or otherwise control one or more node computing resources 914a-914b and/or grouped computing resources 912. In at least one embodiment, resource orchestrator 910 may include a software design infrastructure (“SDI”) management entity for data center 900. In at least one embodiment, resource orchestrator 910 may include hardware, software, or some combination thereof.

In at least one embodiment, as depicted in FIG. 9, framework layer 904 includes, without limitation, a job scheduler 916, a configuration manager 918, a resource manager 920, and a distributed file system 922. In at least one embodiment, framework layer 904 may include a framework to support software 924 of software layer 906 and/or one or more application(s) 926 of application layer 220. In at least one embodiment, software 924 or application(s) 926 may respectively include web-based service software or applications, such as those provided by Amazon Web Services, Google Cloud, and Microsoft Azure. In at least one embodiment, framework layer 904 may be, but is not limited to, a type of free and open-source software web application framework such as Apache SPARK™ (hereinafter “Spark) that may utilize a distributed file system 922 for large-scale data processing (e.g., “big data”). In at least one embodiment, job scheduler 916 may include a Spark driver to facilitate scheduling of workloads supported by various layers of data center 900. In at least one embodiment, configuration manager 918 may be capable of configuring different layers such as software layer 906 and framework layer 904, including Spark and distributed file system 922 for supporting large-scale data processing. In at least one embodiment, resource manager 920 may be capable of managing clustered or grouped computing resources mapped to or allocated for support of distributed file system 922 and job scheduler 916. In at least one embodiment, clustered or grouped computing resources may include grouped computing resources 912 at data center infrastructure layer 902. In at least one embodiment, resource manager 920 may coordinate with resource orchestrator 910 to manage these mapped or allocated computing resources.

In at least one embodiment, software 924 included in software layer 906 may include software used by at least portions of node computing resources 914a-914b, grouped computing resources 912, and/or distributed file system 922 of framework layer 904. One or more types of software may include, but are not limited to, Internet web page search software, e-mail virus scan software, database software, and streaming video content software.

In at least one embodiment, application(s) 926 included in application layer 908 may include one or more types of applications used by at least portions of node computing resources 914a-914b, grouped computing resources 912, and/or distributed file system 922 of framework layer 904. In at least one or more types of applications may include, without limitation, Compute Unified Device Architecture (CUDA) applications, 5G network applications, artificial intelligence applications, data center applications, and/or variations thereof.

In at least one embodiment, any of configuration manager 918, resource manager 920, and resource orchestrator 910 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poorly performing portions of a data center.

### LISTING OF DRAWING ELEMENTS

102 first processor
104 second processor
106 shared memory queue
202 CPU master thread
204 CPU worker thread
206 GPU worker thread
208 GPU master thread
302 Operate a thread of a set of co-executing threads in a first processor to collect a set of tasks
304 Configure a task descriptor for the set of tasks in a memory region shared by the first processor and a second processor
306 Dispatch the task descriptor to a task queue of the second processor
308 Execute a first thread in the second processor to monitor the task queue for the task descriptor
310 Execute one or more second threads in the second processor to perform computations defined by the task descriptor
312 Set with the second threads a result of the computations defined by the task descriptor in the shared memory region
314 Set with the second threads a completed status of the set of tasks in the shared memory region
316 Detect with one or more of the co-executing threads of the first processor the completed status of the set of tasks
318 Combine the result in the shared memory region with a result computed by the set of co-executing threads in the first processor
402 parallel processing unit
404 I/O unit
406 front-end unit
408 scheduler unit
410 work distribution unit
412 hub
414 crossbar
416 NVLink
418 interconnect
420 memory
422 general processing cluster
424 memory partition unit
502 pipeline manager
504 pre-raster operations unit
506 raster engine
508 work distribution crossbar
510 memory management unit
512 data processing cluster
514 primitive engine
516 M-pipe controller
518 streaming multiprocessor
602 raster operations unit
604 level two cache
606 memory interface
702 instruction cache
704 scheduler unit
706 register file
708 core
710 special function unit
712 load/store unit
714 interconnect network
716 shared memory/L1 cache
718 dispatch
802 central processing unit
804 switch
806 parallel processing module
902 communications bus
904 main memory
906 input devices
908 display devices
910 network interface
1002 output data
1004 data assembly
1006 vertex shading
1008 primitive assembly
1010 geometry shading
1012 viewport SCC
1014 rasterization
1016 fragment shading
1018 raster operations
1020 input data
1102 integrated circuit
1104 graphics processing unit
1106 graphics processing unit
1108 central processing unit
1202 network
1204 network
1206 NIC or DPU
1208 NIC or DPU
1210 NIC or DPU
1212 NIC or DPU
1214 NIC or DPU
1216 computing system

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112 (f) for that claim element. Accordingly, claims in this application that do not otherwise include the “means for” [performing a function] construct should not be interpreted under 35 U.S.C § 112 (f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A system comprising:
a graphics processing unit (GPU) and a central processing unit (CPU);
logic to:
configure the CPU to offload a portion of an application to the GPU for execution, the portion of the application comprising a plurality of tasks;
collect portions of the tasks from a set of co-executing threads of the GPU;
configure the GPU to dispatch first portions of the tasks to a plurality of queues for threads of the CPU;
configure the co-executing threads of the GPU to wait for completion indications for the first portions of the tasks; and
configure the co-executing threads of the GPU to respond to the completion indications by combining first partial results of second portions of the tasks from the set of co-executing threads of the GPU with second partial results of the tasks from the threads of the CPU.

2. The system of claim 1, wherein each queue is associated with a different thread of the CPU.

3. The system of claim 1, where the queues are formed in a memory region shared by the CPU and the GPU.

4. The system of claim 1, wherein the tasks comprise a sum of products reduction.

5. The system of claim 1, wherein the first portions of the tasks are dispatched using task descriptors comprising one or more key values identifying data values for the CPU to apply when executing the first portions of the tasks.

6. The system of claim 1, wherein the task descriptors comprise one or more addresses to which to write the second partial results.

7. The system of claim 1, wherein the task queues are first-in-first-out (FIFO) structures and a single thread of the GPU dispatches the task descriptors to the FIFOs in a manner that implements execution ordering of the first portions of the tasks.

8. A method comprising:
at a second processor, receiving a workload from a first processor, the workload comprising a plurality of tasks;
collecting portions of the tasks from a set of co-executing threads in the second processor;
dispatching the portions of the tasks to a plurality of queues for threads of the first processor; and
in response to one or more status indications satisfying a completion condition for the first portions of the tasks, combining first partial results of the tasks from the set of co-executing threads with second partial results of the portions of the tasks from the first processor.

9. The method of claim 8, further comprising:
operating a single thread of the set of co-executing threads in the second processor to collect the portions of the tasks.

10. The method of claim 8, wherein each task queue is associated with a different thread of the first processor.

11. The method of claim 8, wherein the task queues are formed in a memory region shared by the first processor and the second processor.

12. The method of claim 8, wherein the tasks comprise a sum of products reduction.

13. The method of claim 8, wherein the task descriptors comprise one or more identifications of data values for the first processor to apply when executing the portions of the tasks.

14. The method of claim 8, wherein the task descriptors comprise one or more addresses to which to write the second partial results.

15. The method of claim 8, wherein the task queues are first-in-first-out (FIFO) structures and the particular thread of the second processor dispatches the task descriptors to the FIFOs in a manner that implements execution ordering of the tasks.

16. The method of claim 8, wherein the second processor is a graphics processing unit (GPU).

17. The method of claim 8, wherein the first processor is a central processing unit (CPU).

18. A non-transitory machine-readable media comprising instructions, that when applied to a first processor and a second processor, result in:
configuring the first processor to offload a portion of the instructions to the second processor for execution, the offloaded portion of the instructions comprising a plurality of tasks;
configuring the second processor to collect portions of the tasks from the set of co-executing threads;
configuring the second processor to reverse-offload the portions of the tasks to the first processor;
configuring the co-executing threads of the second processor to wait for completion indications for portions of the tasks; and
configuring the co-executing threads of the second processor to combine first partial results of the portions of the tasks from the set of co-executing threads of the second processor with second partial results of the portions of the tasks from the first processor in response to the completion indications.

19. The non-transitory machine-readable media of claim 18 wherein the instructions when applied to a first processor and a second processor, further result in:
the second processor reverse-offloading task descriptors for the portions of the tasks to a plurality of FIFOs formed in a memory region shared by the first processor and the second processor.

20. The non-transitory machine-readable media of claim 19 wherein the instructions when applied to a first processor and a second processor, further result in each of the FIFOs being associated with a different thread of the first processor.

21. The non-transitory machine-readable media of claim 18 wherein the task descriptors comprise identifiers of data values to apply when computing the second partial results and one or more addresses to which to write the second partial results.

22. A data center comprising:
a plurality of cooperative graphics processing unit (GPU) and a central processing unit (CPU) modules;
machine memory comprising instructions that configure the modules to:
configure one or more of the CPUs to offload a portion of an application to one or more of the GPUs for execution, the portion of the application comprising a plurality of tasks;
collect portions of the tasks from a set of co-executing threads of the one or more GPUs;
configure the one or more GPUs to dispatch first portions of the tasks to a plurality of queues for threads of the one or more CPUs;
configure the co-executing threads of the one or more GPUs to wait for completion indications for the first portions of the tasks; and
configure the co-executing threads of the one or more GPUs to respond to the completion indications by combining first partial results of second portions of the tasks from the set of co-executing threads of the one or more GPUs with second partial results of the tasks from the threads of the one or more CPUs.
